(19) United States
(12) Patent Application Publication
(10) Pub. No.: US 2017/0297589 A1
(43) Pub. Date: Oct. 19, 2017

(54) Vertical Rope Climbing Inspection Robot for Ultra-Deep Vertical Shaft Steel-Rope Guide

(71) Applicant: CHINA UNIVERSITY OF MINING AND TECHNOLOGY, Jiangsu (CN)

(72) Inventors: Gongbo ZHOU, Jiangsu (CN); Penghui WANG, Jiangsu (CN); Zhencai ZHU, Jiangsu (CN); Chengxiang WU, Jiangsu (CN); Guohua CAO, Jiangsu (CN); Wei LI, Jiangsu (CN); Yuxing PENG, Jiangsu (CN)

(21) Appl. No.: 15/516,205

(22) PCT Filed: Dec. 28, 2015
(86) PCT No.: PCT/CN2015/099111

§ 371 Date: Mar. 31, 2017

(30) Foreign Application Priority Data
Jul. 2, 2015 (CN) 201510381205.3

(51) Int. Cl. B61B 7/06; H02K 7/08; H02K 11/38; F16H 1/16; B61C 3/00; H02K 7/116; H02K 5/04; F16H 1/14

(52) U.S. Cl. CPC B61B 7/06; H02K 7/116; H02K 7/081; H02K 5/04; H02K 11/38; F16H 1/16; B61C 3/00; F16H 1/14

(57) ABSTRACT

Disclosed is a vertical rope climbing inspection robot for an ultra-deep vertical shaft steel-rope guide. The vertical rope climbing inspection robot comprises an explosion-proof shell, a driving mechanism, a wheel mechanism, a clamping mechanism, a carrying mechanism and an electric control device. The explosion-proof shell comprises an upper driving shell (2), a lower driving shell (5), a driver shell (9), an electric control device shell (8) and a carrying mechanism shell (11). The driving mechanism comprises an upper driving part, a lower driving part and an electric motor driver (21). The wheel mechanism comprises an upper driving wheel part, an upper left side driven wheel part, an upper right side driven wheel part, a lower driving wheel part, a lower left side driven wheel part and a lower right side driven wheel part. The clamping mechanism (16) comprises a left side clamping part and a right side clamping part. The carrying mechanism comprises a movable trolley (11), an intrinsic safety camera (52) and a cradle head (12). The rope climbing inspection robot can meet the explosion-proof requirements of a coal mine, can climb on the ultra-deep vertical shaft steel-rope guide and can monitor the strain of the shaft wall and the structural situation of the derrick in real-time.

### FIELD OF THE INVENTION

The present invention belongs to the technical field of special robots, and particularly relates to an inspection robot that can climb vertically along a steel-rope cage guide in an extra-deep shaft.

### BACKGROUND OF THE INVENTION

In the coal mine field, the robot research is mainly focused on monitoring and rescue, and robots are mainly applied in downhole roadways and at working faces. However, in extra-deep shaft hoisting systems, the shaft may have deformation in longitudinal direction, circumferential direction and radial direction owing to the complex geologic conditions and the time-dependent operating environment, etc. Therefore, it is especially important and urgent to release a rope climbing inspection robot in hoisting shafts to detect potential failures and defects in extra-deep shaft hoisting systems as early as possible, change the present situation of low-efficiency manual inspection in the maintenance period of the hoisting systems, and finally realize real-time shaft health monitoring, so as to improve the safety and reliability of mine shaft hoisting systems and to ensure life and property safety.

Different from the prior art, a rope climbing robot must meet the explosion-proof requirements of the coal mine, must be equipped with appropriate inspection devices and climb the rope vertically and quickly to designated positions for inspection, in the narrow and long shaft space. Hence, there are higher requirements for movement coordination among the mechanisms of the robot and the accuracy of control.

### CONTENTS OF THE INVENTION

Object of the invention: In view of the problems described above and the drawbacks in the prior art, the present invention provides a roller-type robot, which can suspend on the steel-rope cage guide and climbs up and down along the rope vertically in an extra-deep shaft, with a real-time monitoring function, the roller-type robot has uniformly distributed weight, meets the explosion-proof requirements of coal mines, can reach to designated positions in the maintenance period of a shaft hoisting system to monitor the strain condition of the shaft wall and the condition of the rockshaft and shaft frame structure, and transmits the monitoring images wirelessly to a ground control center, so as to improve the equipment maintenance efficiency and enhance the safety of operation of the shaft hoisting system.

To attain the object described above, the present invention employs the following technical scheme: A vertical rope climbing inspection robot for a steel-rope cage guide in an extra-deep shaft, comprising an explosion-proof housing, a driving mechanism, a roller mechanism, a clamping mechanism, a carrying mechanism and an electrical control device;

the explosion-proof housing comprises an upper driving housing, a lower driving housing, a driver housing, an electrical control device housing and a carrying mechanism housing, wherein, the upper driving housing and the lower driving housing are arranged symmetrically at the two ends of the driver housing, one end of the electrical control device housing is connected to the lower driving housing by a hinge, and the other end of the electrical control device housing is connected to the upper driving housing by sealing bolts;

the driving mechanism comprises an upper driving part, a lower driving part and a driver part, wherein, the upper driving part is arranged in the upper driving housing, the lower driving part is arranged in the lower driving housing, and the driver part is arranged in the driver housing, and the driver part is connected to the upper driving housing and the lower driving part respectively;

the roller mechanism comprises an upper driving roller part, an upper left driven roller part, an upper right driven roller part, a lower driving roller part, a lower left driven roller part and a lower right driven roller part, wherein, the upper driving roller part and the lower driving roller part are arranged symmetrically at the upper side and the lower side of the driver housing, the upper left driven roller part and the upper right driven roller part are arranged symmetrically at the two sides of the top of the electrical control device housing, the lower left driven roller part and the lower right driven roller part are arranged symmetrically at the two sides of the bottom of the electrical control device housing, the upper driving roller part is connected to the upper driving part, and the lower driving roller part is connected to the lower driving part;

the clamping mechanism comprises a left clamping part and a right clamping part, wherein, the left clamping part is connected to the upper left driven roller part and the lower left driven roller part, and the right clamping part is connected to the upper right driven roller part and the lower right driven roller part;

the carrying mechanism comprises a moving carriage, an intrinsically safe camera and a PTZ, wherein, the PTZ has an annular shape with a gap, the two ends of the PTZ is provided with limit switches, the bottom of the PTZ is welded with a short stand column and a long stand column, the short stand column is welded to the top surfaces of the upper driving housing and the lower driving housing, the lower end of the long stand column is connected to the electrical control device housing by connecting screws, the moving carriage is arranged on the PTZ, the carrying mechanism housing is arranged on the moving carriage, and the intrinsically safe camera is arranged on the carrying mechanism housing;

the electrical control device is arranged in the electrical control device housing, and the electrical control device is connected to the upper driving part, the lower driving part, the driver part, the moving carriage mechanism and the intrinsically safe camera respectively

Furthermore, the upper driving part comprises a brushless DC motor, a motor retaining plate, an elastic sleeve-shaft pin coupler and a worm-and-gear speed reducer, wherein, the worm-and-gear speed reducer comprises a worm, a worm gear, a first bearing of worm shaft, a first bearing seat of worm shaft, a second bearing of worm shaft and a second bearing seat of worm shaft; the brushless DC motor is arranged on the motor retaining plate, the first bearing of worm shaft is arranged on the first bearing seat of worm shaft, the second bearing of worm shaft is arranged on the second bearing seat of worm shaft, an output shaft of the brushless DC motor is connected to the worm by the elastic sleeve-shaft pin coupler, the worm is arranged on the first bearing of worm shaft and the second bearing of worm shaft, and the worm gear is engaged with the worm; the lower driving part has the same structure as the upper driving part; the driver part comprises a motor driver which is connected to the brushless DC motors of the upper driving part and the lower driving part, respectively.

Furthermore, the worm-and-gear speed reducer further comprises an oil storage sponge support which has oil-immersed sponge which contacts with the worm.

Furthermore, both the upper driving roller part and the lower driving roller part comprise a driving shaft, a driving rubber roller, a first bearing of driving shaft, a first bearing seat of driving shaft, a second bearing of driving shaft, a second bearing seat of driving shaft, a third bearing of driving shaft and a third bearing seat of driving shaft, wherein, the driving shaft is arranged on the first bearing of driving shaft, the second bearing of driving shaft and the third bearing of driving shaft, the first bearing of driving shaft is arranged on the first bearing seat of driving shaft, the second bearing of driving shaft is arranged on the second bearing seat of driving shaft, the third bearing of driving shaft is arranged on the third bearing seat of driving shaft; the first bearing seat of driving shaft and the second bearing seat of driving shaft of the upper driving roller part are welded to the inner side of the upper driving housing, and the third bearing seat of driving shaft of the upper driving roller part is welded to the outer side of the lower driving housing; the first bearing seat of driving shaft and the second bearing seat of driving shaft of the lower driving roller part are welded to the inner side of the lower driving housing, and the third bearing seat of driving shaft of the lower driving roller part is welded to the outer side of the upper driving housing; the driving rubber roller and the worm gear of the upper driving part are arranged on the driving shaft of the upper driving roller part, and the driving rubber roller and the worm gear of the lower driving part are arranged on the driving shaft of the lower driving roller part.

The upper left driven roller part comprises a driven nylon roller, a driven roller supporting rod, a supporting rod connecting part, a driven roller shaft sleeve, a driven long bolt, a pair of driven roller bearings and a driven nut, wherein, the supporting rod connecting part is welded to the outer side of the explosion-proof housing of the electrical control device, one end of the driven roller supporting rod is connected to the supporting rod connecting part by a pin shaft, the other end of the driven roller supporting rod is provided with a U-shaped frame, the driven long bolt is mounted on the U-shaped frame by the driven nut, the driven roller shaft sleeve is arranged on the driven long bolt, the pair of driven roller bearings are arranged at the two ends of the driven roller shaft sleeve, and the inner ring of the driven nylon roller is sleeve arranged over the driven roller shaft sleeve and the pair of driven roller bearings; the upper right driven roller part, the lower left driven roller part and the lower right driven roller part have the same structure as the upper left driven roller part.

Furthermore, both the worm gear and the driving rubber roller are radially positioned on the driving shaft through a key connection, a copper shaft sleeve is arranged on the driving shaft between the worm gear and the second bearing of driving shaft, the width of the fitting surface between the copper shaft sleeve and the driving shaft is equal to the diameter of the driving shaft at the fitting surface, a shaft shoulder is arranged on the driving shaft at one side of the driving rubber roller, and a driving shaft sleeve is arranged on the driving shaft at the other side of the driving rubber roller.

Furthermore, the circumferential surfaces of the driving rubber roller and the driven nylon roller of the roller mechanism are inner concave curved surfaces.

Furthermore, the left clamping part comprises a cylindrical rotary block of supporting rod, a spring, a spring bolt connecting part, a clamping long bolt and a clamping nut, wherein, the cylindrical rotary block of supporting rod is connected to the driven roller supporting rod by a pin shaft and has a through-hole at its center, a protruding supporting part having a slide groove is welded to the outer side of the electrical control device housing, the spring bolt connecting part is in a cylindrical shape and passes through the slide groove of the protruding supporting part, the lower end of the clamping long bolt is connected to the upper end of the spring bolt connecting part, the upper end of the clamping long bolt passes through the through-hole of the cylindrical rotary block of supporting rod and the clamping nut sequentially, the upper end of the spring is connected to the lower end of the spring bolt connecting part, and the lower end of the spring passes through the through-hole of the cylindrical rotary block of supporting rod and is fixed.

Furthermore, the moving carriage comprises a mini-type DC speed-reducing motor, a pair of bevel gears, a rotation shaft, a pair of rotation shaft bearings, a walking gear and a walking roller, wherein, the mini-type DC speed-reducing motor, the pair of bevel gears and the rotation shaft are arranged at inner side of the carrying mechanism housing, the walking gear and the walking roller are arranged at the outer side of the carrying mechanism housing, an output shaft of the mini-type DC speed-reducing motor is connected to the rotation shaft by the pair of bevel gears, the rotation shaft is arranged through the pair of rotation shaft bearings, one end of the rotation shaft is connected to the walking gear, the outer ring of the PTZ is provided with a V-shaped track matching with the walking roller, and the inner ring of the PTZ is provided with gear teeth which are engaged with the walking gear.

Furthermore, the electrical control device comprises a battery, a controller, a voltage converter module and an intrinsically safe wireless communication module, wherein, the battery is connected to the voltage converter module, the voltage converter module is connected to the controller, the intrinsically safe wireless communication module, the brushless DC motor, the motor driver and the mini-type DC speed-reducing motor respectively, and the controller is connected to the motor driver, the brushless DC motor, the mini-type DC speed-reducing motor, the intrinsically safe wireless communication module and the intrinsically safe camera respectively.

Furthermore, the inspection robot further comprises a lead-in device, the lead-in device comprises a driving mechanism lead-in device, an electrical control device lead-in device and a carrying mechanism lead-in device, wherein, the driving mechanism lead-in device is arranged on the driver housing, the electrical control device lead-in device is arranged on the electrical control device housing, and the carrying mechanism lead-in device is arranged on the carrying mechanism housing.

Beneficial effects: (1) the rope climbing inspection robot provided in the present invention can meet the explosion-proof requirements of coal mines, can suspend on and climb up and down along a steel-rope cage guide in an extra-deep shaft, can monitor the strain of shaft wall and the condition of shaft frame structure in the hoisting shaft maintenance period, and has a good self-locking feature, move smoothly and steadily; the mechanisms of the robot can move separately and can be controlled fully; the carrying mechanism can be expanded to carry other sensing devices. Thus, the robot greatly improves the maintenance efficiency and provides a reliable safeguard for safe operation of a hoisting system; (2) the rollers employ a inner concave curved surface, which increases the area of contact with the arc surface of the steel wire rope; the driving roller is made of a rubber material to increase the friction force between the roller surface and the steel wire rope surface; the driven roller is made of a nylon material to reduce the roller weight and decrease the rotation resistance of the roller while ensuring the hardness of the roller; (3) the driving mechanism utilizes the self-flocking feature of a worm-and-gear speed reducer, so that the robot can suspend on the steel wire rope as long as the friction force is enough; (4) the worm-and-gear speed reducer is mounted with oil storage sponge, which can lubricate the worm gear and the worm, so as to reduce mechanical wear; (5) the pre-tightening force of the clamping mechanism is adjustable, and thereby the applicability of the rope climbing robot to the diameter of the steel wire rope is improved; (6) the driving mechanism and the carrying mechanism can operate separately, the moving carriage runs and rotates on the PTZ smoothly and steadily; thus, a steady and omnidirectional image acquisition platform is provided for inspection; (7) the electrical control device can calculate the coordinates of the robot in the shaft in real time, to prevent the driving roller from skidding and enhances the purposiveness of the control.

### DESCRIPTION OF THE DRAWINGS

FIG. 1 is a front view of the rope climbing inspection robot according to the present invention;

FIG. 2 is a rear view of the rope climbing inspection robot according to the present invention;

FIG. 3 is a structural diagram of the upper driving part of the driving mechanism according to the present invention;

FIG. 4 is a structural diagram of the upper driving roller part of the roller mechanism according to the present invention;

FIG. 5 is a structural diagram of the lower driving roller part of the roller mechanism according to the present invention;

FIG. 6 is a structural diagram of the upper left driven roller part of the roller mechanism according to the present invention;

FIG. 7 is a structural diagram of the left clamping part of the clamping mechanism according to the present invention;

FIG. 8 is a structural diagram of the cylindrical rotary block of supporting rod of the clamping mechanism according to the present invention;

FIG. 9 is a structural diagram of the moving carriage of the carrying mechanism according to the present invention;

FIG. 10 is a schematic diagram illustrating the positions of the modules in the electrical control device part according to the present invention;

FIG. 11 is a schematic diagram illustrating the control principle of the electrical control device according to the present invention,

In the figures: 1—steel wire rope; 2—upper driving housing; 3—explosion-proof flange; 4—driving mechanism lead-in device; 5—lower driving housing; 6—hinge; 7—electrical control device lead-in device; 8—electrical control device housing; 9—driver housing; 10—carrying mechanism lead-in device; 11—carrying mechanism housing; 12—PTZ; 13—short stand column; 14—long stand column; 15—connecting screw; 16—clamping mechanism; 17—sealing bolt; 18—supporting rod connecting part; 19—limit switch; 20—brushless DC motor; 21—motor driver; 22—motor retaining plate; 23—elastic sleeve-shaft pin coupler; 24—first bearing of worm shaft; 25—second bearing of worm shaft; 26—oil storage sponge support; 27—worm gear; 28—first bearing seat of worm shaft; 29—second bearing seat of worm shaft; 30—worm; 31—first bearing of driving shaft; 32—second bearing of driving shaft; 33—first bearing seat of driving shaft; 34—second bearing seat of driving shaft; 35—driving shaft; 36—driving rubber roller; 37—driving shaft sleeve; 38—third bearing of driving shaft; 39—third bearing seat of driving shaft; 40—copper shaft sleeve; 41—driven roller supporting rod; 42—pair of driven roller bearings; 43—driven nylon roller; 44—driven roller shaft sleeve; 45—driven long bolt; 46—driven nut; 47—cylindrical rotary block of supporting rod; 48—spring; 49—spring bolt connecting part; 50—clamping long bolt; 51—clamping nut; 52—intrinsically safe camera; 53—mini-type DC speed-reducing motor; 54—pair of rotation shaft bearings; 55—rotation shaft; 56—pair of bevel gears; 57—walking gear; 58—walking roller; 59—intrinsically safe wireless communication module; 60—controller; 61—voltage converter module; 62—battery; 63—protruding supporting part.

### DETAILED DESCRIPTION OF THE EMBODIMENTS

Hereunder the present invention will be further detailed, with reference to the accompanying drawings.

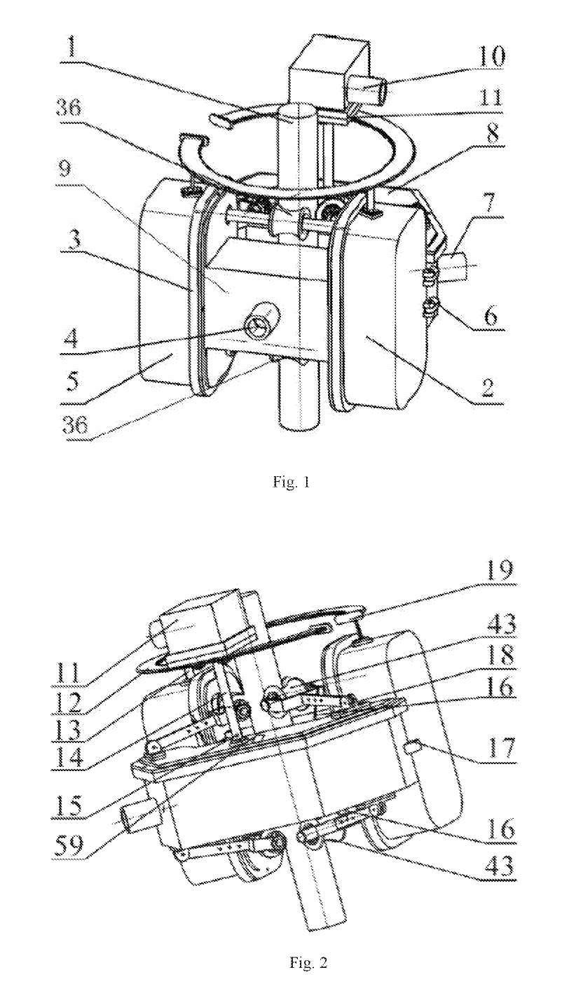

As shown in FIGS. 1 and 2, the roller-type rope climbing inspection robot for a steel-rope cage guide in an extra-deep shaft comprises an explosion-proof housing, a driving mechanism, a roller mechanism, a clamping mechanism 16, a carrying mechanism, an electrical control device and a lead-in device.

The explosion-proof housing comprises an upper driving housing 2, a lower driving housing 5, a driver housing 9, an electrical control device housing 8 and a carrying mechanism housing 11. The upper driving housing 2 and the lower driving housing 5 are arranged symmetrically at the two ends of the driver housing 9, the driver housing 9 is connected to both the upper driving housing 2 and the lower driving housing 5 by an explosion-proof flange 3 respectively, one end of the electrical control device housing 8 is connected to the lower driving housing 5 by a hinge 6 in a rotatable manner, and the other end of the electrical control device housing 8 is connected to the upper driving housing 2 by sealing bolts 17. The wall of the explosion-proof housing has thickness of 6 mm, and the explosion-proof flange 3 has thickness of 10 mm.

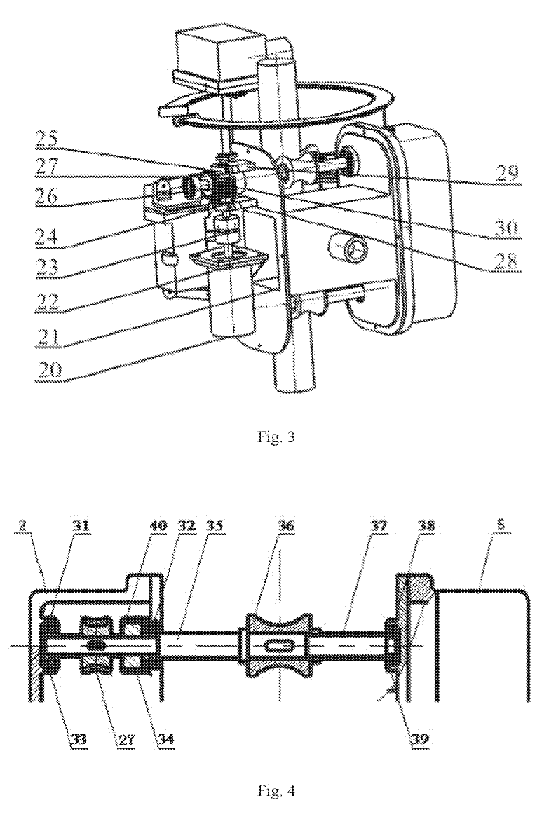

As shown in FIG. 3, the driving mechanism comprises an upper driving part, a lower driving part and a driver part. The upper driving part is arranged in the upper driving housing 2, and comprises a brushless DC motor 20, a motor retaining plate 22, an elastic sleeve-shaft pin coupler 23 and a worm-and-gear speed reducer, wherein, the worm-and-gear speed reducer comprises a worm 30, a worm gear 27, a first bearing of worm shaft 24, a first bearing seat of worm shaft 28, a second bearing of worm shaft 25, a second bearing seat of worm shaft 29 and an oil storage sponge support 26. The brushless DC motor 20 is arranged on the motor retaining plate 22, the first bearing of worm shaft 2.4 is arranged on the first bearing seat of worm shaft 28, the second bearing of worm shaft 25 is arranged on the second bearing seat of worm shaft 29, an output shaft of the brushless DC motor 20 is connected to the worm 30 by the elastic sleeve-shaft pin coupling 23, the worm 30 is arranged on the first bearing of worm shaft 24 and the second bearing of worm shaft 25, and the worm gear 27 is engaged with the worm 30. The oil storage sponge support 26 has a layer of oil-immersed sponge, which contacts with the worm 30 to lubricate the worm gear 27 and the worm 30. The lower driving part is arranged in the lower driving housing 5, and has the same structure as the upper driving part. The driver part is arranged in the driver housing 9, and comprises a motor driver 21, the motor driver 21 is connected to the brushless DC motors 20 of the upper driving part and the lower driving part.

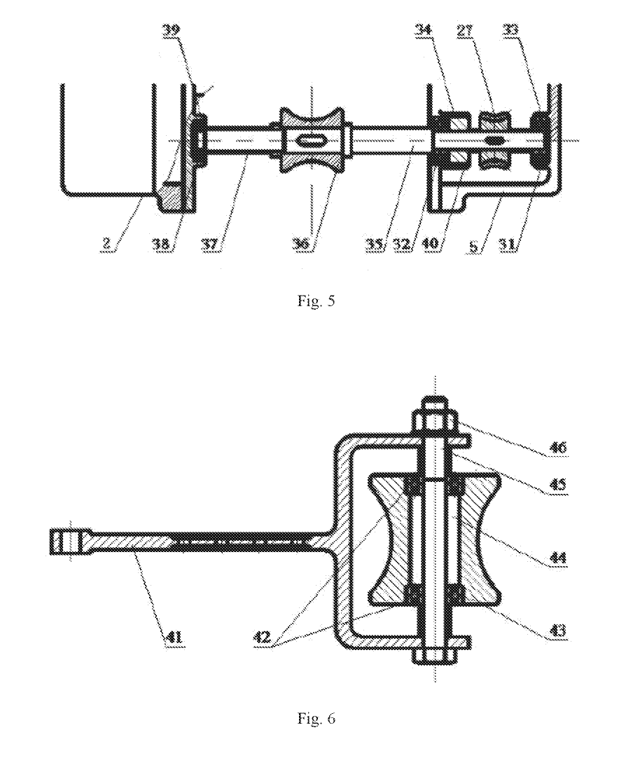

As shown in FIGS. 4, 5 and 6, the roller mechanism comprises an upper driving roller part, an upper left driven roller part, an upper right driven roller part, a lower driving roller part, a lower left driven roller part and a lower right driven roller part, wherein, the upper driving roller part and the lower driving roller part are arranged symmetrically at the upper side and the lower side of the driver housing 9, the upper left driven roller part and the upper right driven roller part are arranged symmetrically at the two sides of the top of the electrical control device housing 8, and the lower left driven roller part and the lower right driven roller part are arranged symmetrically at the two sides of the bottom of the electrical control device housing 8.

Both the upper driving roller part and the lower driving roller part comprise a driving shaft 35, a driving rubber roller 36, a driving shaft sleeve 37, a first bearing of driving shaft 31, a first bearing seat of driving shaft 33, a second bearing of driving shaft 32, a second bearing seat of driving shaft 34, a third bearing of driving shaft 38, a third bearing seat of driving shaft 39 and a copper shaft sleeve 40. The driving shaft 35 is arranged on the first bearing of driving shaft 31, the second bearing of driving shaft 32 and the third bearing of driving shaft 38, the first bearing of driving shaft 31 is arranged on the first bearing seat of driving shaft 33, the second bearing of driving shaft 32 is arranged on the second bearing seat of driving shaft 34, the third bearing of driving shaft 38 is arranged on the third bearing seat of driving shaft 39; the first bearing seat of driving shaft 33 and the second bearing seat of driving shaft 34 of the upper driving roller part are welded to the inner side of the upper driving housing 2, and the third bearing seat of driving shaft 39 of the upper driving roller part is welded to the outer side of the lower driving housing 5; the first bearing seat of driving shaft 33 and the second bearing seat of driving shaft 34 of the lower driving roller part are welded to the inner side of the lower driving housing 5, and the third bearing seat of driving shaft 39 of the lower driving roller part is welded to the outer side of the upper driving housing 2; the driving rubber roller 36 and the worm gear 27 of the upper driving part are arranged on the driving shaft 35 of the upper driving roller part, and the driving rubber roller 36 and the worm gear 27 of the lower driving part are arranged on the driving shaft 35 of the lower driving roller part. Both the worm gear 27 and the driving rubber roller 36 are radially positioned on the driving shaft 35 through a key connection. A copper shaft sleeve 40 is arranged on the driving shaft 35 between the worm gear 27 and the second bearing of driving shaft 32, the width of the fitting surface between the copper shaft sleeve 40 and the driving shaft 35 is equal to the diameter of the driving shaft 35 at the fitting surface, the copper shaft sleeve 40 is configured to axially position the worm gear 27 and the second bearing of driving shaft 32 and to attain an explosion-proof effect. The outer circumferential surface of the driving rubber roller 36 is a inner concave curved surface, a shaft shoulder is arranged on the driving shaft 35 at one side of the driving rubber roller 36, a driving shaft sleeve 37 is arranged on the driving shaft 35 at the other side of the driving rubber roller 36, and the driving rubber roller 36 is axially positioned by means of the shaft shoulder and the driving shaft sleeve 37.

The upper left driven roller part comprises a driven nylon roller 43, a driven roller supporting rod 41, a supporting rod connecting part 18, a driven roller shaft sleeve 44, a driven long bolt 45, a pair of driven roller bearings 42 and a driven nut 46. The supporting rod connecting part 18 is welded to the outer side of the explosion-proof housing 8 of the electrical control device, one end of the driven roller supporting rod 41 is connected to the supporting rod connecting part 18 by a pin shaft, the other end of the driven roller supporting rod 41 is provided with a U-shaped frame, the driven long bolt 45 is mounted on the U-shaped frame by the driven nut 46, the driven roller shaft sleeve 44 is arranged on the driven long bolt 45, the pair of driven roller bearings 42 are arranged on the two ends of the driven roller shaft sleeve 44, and the pair of driven roller bearings 42 is a pair of deep groove ball bearings; the inner ring of the driven nylon roller 43 is sleeve arranged over the driven roller shaft sleeve 44 and the pair of driven roller bearings 42, and the circumferential surface of the driven nylon roller 43 is also a inner concave curved surface. The upper right driven roller part, the lower left driven roller part and the lower right driven roller part have the same structure as the upper left driven roller part.

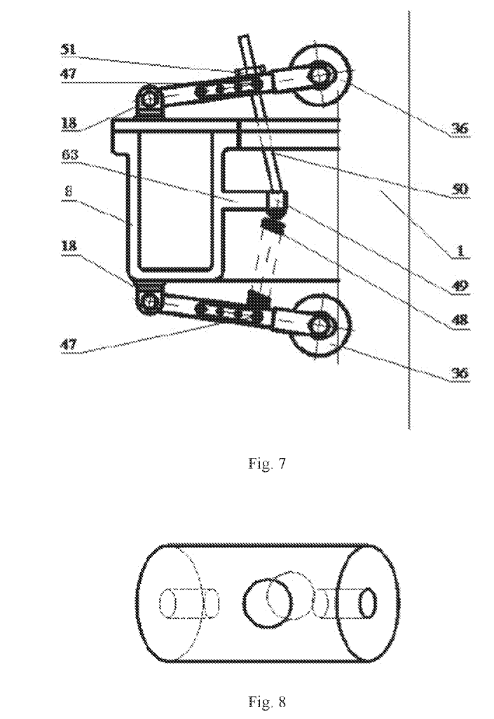

As shown in FIGS. 7 and 8, the clamping mechanism 16 comprises a left clamping part and a right clamping part, wherein, the left clamping part is connected to the upper left driven roller part and the lower left driven roller part, and the right clamping part is connected to the upper right driven roller part and the lower right driven roller part.

The left clamping part comprises a cylindrical rotary block of supporting rod 47, a spring 48, a spring bolt connecting part 49, a clamping long bolt 50 and a clamping nut 51. The cylindrical rotary block of supporting rod 47 is connected to the driven roller supporting rod 41 by a pin shaft in a rotatable manner and has a through-hole at its center, a protruding supporting part 63 having a slide groove is welded to the outer side of the electric control device housing 8, the spring bolt connecting part 49 has a cylindrical shape and passes through the slide groove of the protruding supporting part 63 and can slide freely in the slide groove, the lower end of the clamping long bolt 50 is connected to the upper end of the spring bolt connecting part 49, the upper end of the clamping long bolt 50 passes through the through-hole of the cylindrical rotary block of supporting rod 47 and the clamping nut 51 sequentially, the upper end of the spring 48 is connected to the lower end of the spring bolt connecting part 49, and the lower end of the spring 48 passes through the through-hole of the cylindrical rotary block of supporting rod 47 and is fixed. The clamping force of the driven nylon roller 43 of the upper left driven roller part can be adjusted by rotating the clamping nut 51. The spring 48 ensures the clamping force of the driven nylon roller 43 of the lower left driven roller part.

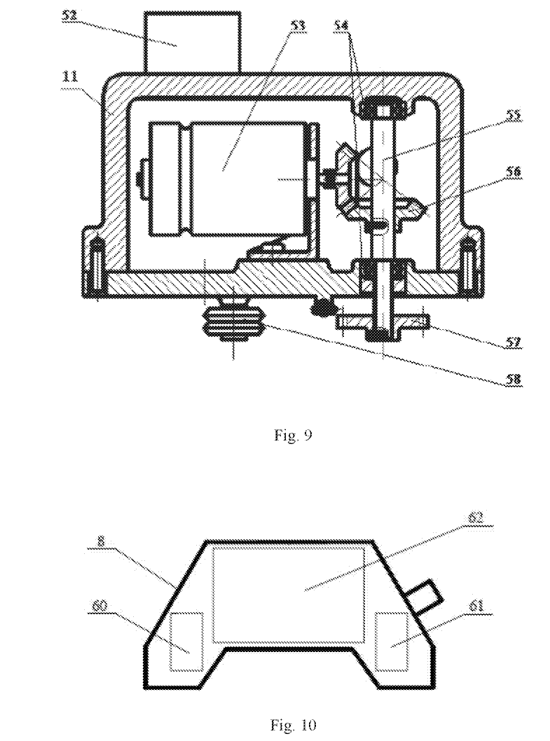

As shown in FIG. 9, the carrying mechanism comprises a moving carriage, an intrinsically safe camera 52 and a PTZ 12, wherein, the PTZ 12 has an annular shape with a gap, the two ends of the PTZ is provided with limit switches 19, the bottom of the PTZ is welded with a short stand column 13 and a long stand column 14, the short stand column 13 is connected to the top surface of the upper driving housing 2 and the lower driving housing 5, the lower end of the long stand column 14 is connected to the electrical control device housing 8 by connecting screws 15, the moving carriage is arranged on the PTZ 12, the carrying mechanism housing 11 is arranged on the moving carriage, and the intrinsically safe camera 52 is arranged on the carrying mechanism housing 11. The moving carriage comprises a mini-type DC speed-reducing motor 53, a pair of bevel gears 56, a rotation shaft 55, a pair of rotation shaft bearings 54, a walking gear 57 and a walking roller 58, wherein, the mini-type DC speed-reducing motor 53, the pair of bevel gears 56 and the rotation shaft 55 are arranged at inner side of the carrying mechanism housing 11, the walking gear 57 and the walking roller 58 are arranged at the outer side of the carrying mechanism housing 11, an output shaft of the mini-type DC speed-reducing motor 53 is connected to the rotation shaft 55 by the pair of bevel gears 56, the rotation shaft 55 is arranged through the pair of rotation shaft bearings 54, and one end of the rotation shaft 55 is connected with the walking gear 57. The outer ring of the PTZ 12 is provided with a V-shaped track matching with the walking roller 58, the walking roller 58 can roll along the V-shaped track; the inner ring of the PTZ 12 is provided with gear teeth which are engage with the walking gear 57.

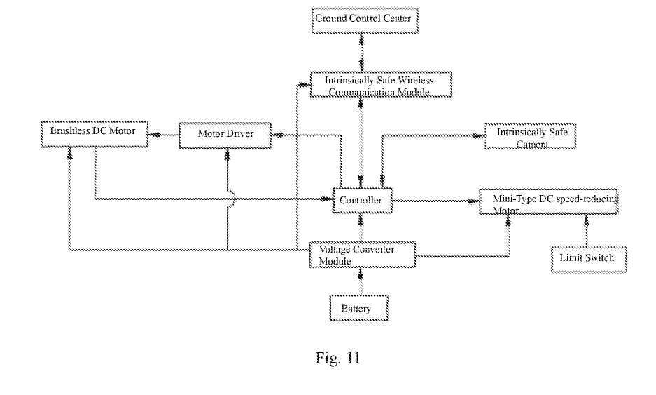

As shown in FIGS. 10 and 11, the electrical control device is arranged in the electrical control device housing 8, and comprises a battery 62, a controller 60, a voltage converter module 61 and an intrinsically safe wireless communication module 59, wherein, the intrinsically safe wireless communication module 59 may be mounted on the top of the electrical control device housing 8 alternatively. The battery 62 is connected to the voltage converter module 61, the voltage converter module 61 is connected to the controller 60, the intrinsically safe wireless communication module 59, the brushless DC motor 20, the motor driver 21 and the mini-type DC speed-reducing motor 53 respectively, and the controller 60 is connected to the motor driver 21, the brushless DC motor 20, the mini-type DC speed-reducing motor 53, the intrinsically safe wireless communication module 59 and the intrinsically safe camera 52 respectively.

As shown in FIGS. 1 and 2, to meet the explosion-proof requirements of the coal mine, a special treatment must be made at the lead-in position of the explosion-proof housing cable, i.e., a lead-in device is installed. The lead-in device comprises a driving mechanism lead-in device 4, an electrical control device lead-in device 7 and a carrying mechanism lead-in device 10. The driving mechanism lead-in device 4 is arranged on the driver housing 9, the electrical control device lead-in device 7 is arranged on the electrical control device housing 8, and the carrying mechanism lead-in device 10 is arranged on the carrying mechanism housing 11; the driving mechanism lead-in device 4, the electrical control device lead-in device 7 and the carrying mechanism lead-in device 10 comprises a straight connection joint and a communicating joint respectively, wherein, the straight connection section is welded from the outer side of the explosion proof housing, while the communicating section is welded from the inner side of the explosion proof housing.

The method for using the rope climbing inspection robot provided in the present invention is as follows:

Step 1. Installation process: First, verify the diameter of the steel wire rope 1 is within the rope climbing diameter range of the rope climbing inspection robot. To install the robot at a designated start position, loosen and pull out of the sealing bolts 17 and the connecting screws 15, so that the electrical control device housing 8 can be rotated around the hinge 6; leave an opening aligned vertically to the gap of the PTZ 12, inserting the steel wire rope 1 through the opening, fix the two driving rubber rollers 36 and the four driven nylon rollers 43 in a way that the six rollers are in central symmetry in relation to the central axis of the steel wire rope 1 and the entire robot is in symmetrical distribution around the steel wire rope 1; rotate back the electrical control device housing 8, and tighten up the sealing bolts 17 and the connecting screws 15, to seal and fix the entire robot.

Step 2. Commissioning stage: Ensure the robot can climb up and down along the steel wire rope and suspend on the steel wire rope, and ensure the robot is in a balanced state; tighten up the clamping nuts 51 on the two clamping long bolts 50, and utilize the self-locking feature of the worm-and-gear speed reducer to enable the robot can suspend by itself without the aid of any external force. Start commissioning on that basis, if the driving rubber roller 36 skids on surface of the steel wire rope 1 when the brushless DC motor 20 operates normally, further tighten up the clamping nut 51 till the pre-tightening force is appropriate and the robot can climb up and down normally.

Step 3. Formal walking stage: A startup and walking command is issued from a ground control center, the command is received by the intrinsically safe wireless communication module 59 and transmitted to the controller 60; the controller 60 controls the rotation direction and rotation speed of the brushless DC motor 20 by the motor driver 21, the brushless DC motor 20 drives the worm 30 by the elastic sleeve-shaft pin coupler 23, the worm 30 is engaged with the worm gear 27 and drives the driving shaft 35 to rotate, and thereby drives the driving rubber roller 36 to rotate; thus, the driven nylon roller 43 rotates accordingly and reaches to a designated position. The controller 60 calculates the coordinates of the robot in the shaft with a RSSI algorithm in real time, and judges whether the driving rollers of the robot skid on site, and makes the control from the ground control center more purposive.

Step 4. Inspection stage: After the robot reaches to a designated position, the controller 60 receives a stop signal, and controls the brushless DC motor 20 to stop, so that the robot suspends there. The controller 60 receives signals from the ground control center and controls the moving carriage to rotate along the PTZ 12, and starts the mini-type DC speed-reducing motor 53; the mini-type DC speed-reducing motor 53 drives the rotation shaft 55 by means of the engagement of the pair of bevel gears 56 to rotate, the rotation shaft 55 drives the walking gear 57 to roll along the inner ring of the PTZ 12 engaged with the walking gear 57, and thereby the walking roller 58 is also driven to roll along the outer ring of the PTZ 12, so that the moving carriage 11 runs smoothly, and inspection is carried out via the intrinsically safe camera 52. The limit switches 19 are mounted at the two ends of the gap of the PIZ 12. Therefore, when the moving carriage moves to either end of the gap, it will touch the limit switch 19 and stop accordingly, or move in the reversed direction under a command from the controller 60.

Step 5. Return stage: The rope climbing inspection robot can go to different designated positions to execute an inspection task as instructed by control commands; meanwhile, the controller 60 detects the remaining power capacity of the battery 62 and judges whether the remaining power capacity is enough for the robot to return to the original installation position according to the coordinates of the robot in the shaft; if the remaining power capacity is not enough, the controller 60 will send an alert to the ground control center; the robot will return to the original installation position when it receives a return command from the ground control center.

While the present invention has been illustrated and described with reference to some preferred embodiments, the present invention is not limited to these. Those skilled in the art should recognize that various variations and modifications can be made without departing from the spirit and scope of the present invention. All of such variations and modifications shall be deemed as falling into the protected scope of the present invention.

1. A vertical rope climbing inspection robot for a steel-rope cage guide in an extra-deep shaft, wherein, comprises an explosion-proof housing, a driving mechanism, a roller mechanism, a clamping mechanism (16), a carrying mechanism and an electrical control device;
the explosion-proof housing comprises an upper driving housing (2), a lower driving housing (5), a driver housing (9), an electrical control device housing (8) and a carrying mechanism housing (11), wherein, the upper driving housing (2) and the lower driving housing (5) are arranged symmetrically at the two ends of the driver housing (9), one end of the electrical control device housing (8) is connected to the lower driving housing (5) by a hinge (6), and the other end of the electrical control device housing (8) is connected to the upper driving housing (2) by sealing bolts (17);
the driving mechanism comprises an upper driving part, a lower driving part and a driver part, wherein, the upper driving part is arranged in the upper driving housing (2), the lower driving part is arranged in the lower driving housing (5), and the driver part is arranged in the driver housing (9), and the driver part is connected to the upper driving part and the lower driving part respectively;
the roller mechanism comprises an upper driving roller part, an upper left driven roller part, an upper right driven roller part, a lower driving roller part, a lower left driven roller part and a lower right driven roller part, wherein, the upper driving roller part and the lower driving roller part are arranged symmetrically at the upper side and the lower side of the driver housing (9), the upper left driven roller part and the upper right driven roller part are arranged symmetrically at the two sides of the top of the electrical control device housing (8), the lower left driven roller part and the lower right driven roller part are arranged symmetrically at the two sides of the bottom of the electrical control device housing (8), the upper driving roller part is connected to the upper driving part, and the lower driving roller part is connected to the lower driving part;
the clamping mechanism (16) comprises a left clamping part and a right clamping part, wherein, the left clamping part is connected to the upper left driven roller part and the lower left driven roller part, and the right clamping part is connected to the upper right driven roller part and the lower right driven roller part;
the carrying mechanism comprises a moving carriage, an intrinsically safe camera (52) and a PTZ (12), wherein, the PTZ (12) has an annular shape with a gap, the two ends of the PTZ (12) is provided with limit switches (19), the bottom of the PTZ is welded with a short stand column (13) and a long stand column (14), the short stand column (13) is connected to the top surface of the upper driving housing (2) and the lower driving housing (5), the lower end of the long stand column (1.4) is connected to the electrical control device housing (8) by connecting screws (15), the moving carriage is arranged on the P′17 (12), the carrying mechanism housing (11) is arranged on the moving carriage, and the intrinsically safe camera (52) is arranged on the carrying mechanism housing (11);
the electrical control device is arranged in the electrical control device housing (8), and the electrical control device is connected to the upper driving part, the lower driving part, the driver part, the moving carriage mechanism and the intrinsically safe camera (52) respectively,

2. The vertical rope climbing inspection robot for a steel-rope cage guide in an extra-deep shaft according to claim 1, wherein, the upper driving part comprises a brushless DC motor (20), a motor retaining plate (22), an elastic sleeve-shaft pin coupler (23) and a worm-and-gear speed reducer, wherein, the worm-and-gear speed reducer comprises a worm (30), a worm gear (27), a first bearing of worm shaft (24), a first bearing seat of worm shaft (28), a second bearing of worm shaft (25) and a second bearing seat of worm shaft (29); the brushless DC motor (20) is arranged on the motor retaining plate (22), the first bearing of worm shaft (24) is arranged on the first bearing seat of worm shaft (28), the second bearing of worm shaft (25) is arranged on the second bearing seat of worm shaft (29), an output shaft of the brushless DC motor (20) is connected to the worm (30) by the elastic sleeve-shaft pin coupler (23), the worm (30) is arranged on the first bearing of worm shaft (24) and the second bearing of worm shaft (25), and the worm gear (27) is engaged with the worm (30); the lower driving part has the same structure as the upper driving part; the driver part comprises a motor driver (21), which is connected to the brushless DC motors (20) of the upper driving part and the lower driving part, respectively.

3. The vertical rope climbing inspection robot for a steel-rope cage guide in an extra-deep shaft according to claim 2, wherein, the worm-and-gear speed reducer further comprises an oil storage sponge support (26), the oil storage sponge support (26) has oil-immersed sponge which contacts with the worm (30).

4. The vertical rope climbing inspection robot for a steel-rope cage guide in an extra-deep shaft according to claim 2, wherein, both the upper driving roller part and the lower driving roller part comprise a driving shaft (35), a driving rubber roller (36), a first bearing of driving shaft (31), a first bearing seat of driving shaft (33), a second bearing of driving shaft (32), a second bearing seat of driving shaft (34), a third bearing of driving shaft (38) and a third bearing seat driving shaft (39), wherein, the driving shaft (35) is arranged on the first bearing of driving shaft (31), the second bearing of driving shaft (32) and the third bearing of driving shaft (38), the first bearing of driving shaft (31) is arranged on the first bearing seat of driving shaft (33), the second bearing of driving shaft (32) is arranged on the second bearing seat of driving shaft (34), the third hearing of driving shaft (38) is arranged on the third bearing seat of driving shaft (39); the first hearing seat of driving shaft (33) and the second bearing seat of driving shaft (34) of the upper driving roller part are welded to the inner side of the upper driving housing (2), and the third bearing seat of driving shaft (39) of the upper driving roller part is welded to the outer side of the lower driving housing (5); the first hearing seat of driving shaft (33) and the second bearing seat of driving shaft (34) of the lower driving roller part are welded to the inner side of the lower driving housing (5), and the third bearing seat of driving shaft (39) of the lower driving roller part is welded to the outer side of the upper driving housing (2); the driving rubber roller (36) and the worm gear (27) of the upper driving part are arranged on the driving shaft (35) of the upper driving roller part, and the driving rubber roller (36) and the worm gear (27) of the lower driving part are arranged on the driving shaft (35) of the lower driving roller part;
the upper left driven roller part comprises a driven nylon roller (43), a driven roller supporting rod (41), a supporting rod connecting part (18), a driven roller shaft sleeve (44), a driven long bolt (45), a pair of driven roller bearings (42) and a driven nut (46), wherein, the supporting rod connecting part (18) is welded to the outer side of the explosion-proof housing (8) of the electrical control device, one end of the driven roller supporting rod (41) is connected to the supporting rod connecting part (18) by a pin shaft, the other end of the driven roller supporting rod (41) is provided with a U-shaped frame, the driven long bolt (45) is mounted on the U-shaped frame by the driven nut (46), the driven roller shaft sleeve (44) is arranged on the driven long bolt (45), the pair of driven roller bearings (42) are arranged at the two ends of the driven roller shaft sleeve (44), and the inner ring of the driven nylon roller (43) is sleeve arranged over the driven roller shaft sleeve (44) and the pair of driven roller bearings (42); the upper right driven roller part, the lower left driven roller part and the lower right driven roller part have the same structure as the upper left driven roller part.

5. The vertical rope climbing inspection robot for a steel-rope cage guide in an extra-deep shaft according to claim 4, wherein, both the worm gear (27) and the driving rubber roller (36) are radially positioned on the driving shaft (35) through a key connection, a copper shaft sleeve (40) is arranged on the driving shaft (35) between the worm gear (27) and the second bearing of driving shaft (32) in a way that the width of the fitting surface between the copper shaft sleeve (40) and the driving shaft (35) is equal to the diameter of the driving shaft (35) at the fitting surface, a shaft shoulder is arranged on the driving shaft (35) at one side of the driving rubber roller (36), and a driving shaft sleeve (37) is arranged on the driving shaft (35) at the other side of the driving rubber roller (36).

6. The vertical rope climbing inspection robot for a steel-rope cage guide in an extra-deep shaft according to claim 4, wherein, the circumferential surfaces of the driving rubber roller (36) and the driven nylon roller (43) of the roller mechanism are inner concave curved surfaces.

7. The vertical rope climbing inspection robot for a steel-rope cage guide in an extra-deep shaft according to claim 4, wherein, the left clamping part comprises a cylindrical rotary block of supporting rod (47), a spring (48), a spring bolt connecting part (49), a clamping long bolt (50) and a clamping nut (51), wherein, the cylindrical rotary block of supporting rod (47) is connected to the driven roller supporting rod (41) by a pin shaft and has a through-hole at its center, a protruding supporting part (63) having a slide groove is welded to the outer side of the electrical control device housing (8), the spring bolt connecting part (49) has a cylindrical shape and passes through the slide groove of the protruding supporting part (49) the lower end of the clamping long bolt (50) is connected to the upper end of the spring bolt connecting part (49), the upper end of the clamping long bolt (50) passes through the through-hole of the cylindrical rotary block of supporting rod (47) and the clamping nut (51) sequentially, the upper end of the spring (48) is connected to the lower end of the spring bolt connecting part (49), and the lower end of the spring (48) passes through the through-hole of the cylindrical rotary block of supporting rod (47) and is fixed.

8. The vertical rope climbing inspection robot for a steel-rope cage guide in an extra-deep shaft according to claim 7, wherein, the moving carriage comprises a mini-type DC speed-reducing motor (53), a pair of bevel gears (56), a rotation shaft (55), a pair of rotation shaft bearings (54), a walking gear (57) and a walking roller (58), wherein, the mini-type DC speed-reducing motor (53), the pair of bevel gears (56) and the rotation shaft (55) are arranged at inner side of the carrying mechanism housing (11), the walking gear (57) and the walking roller (58) are arranged at the outer side of the carrying mechanism housing (11), an output shaft of the mini-type DC speed-reducing motor (53) is connected to the rotation shaft (55) by the pair of bevel gears (56), the rotation shaft (55) is arranged through the pair of rotation shaft bearings (54), one end of the rotation shaft (55) is connected to the walking gear (57), the outer ring of the PTZ (12) is provided with a V-shaped track matching with the walking roller (58), and the inner ring of the PTZ (12) is provided with gear teeth which are engaged with the walking gear (57).

9. The vertical rope climbing inspection robot for a steel-rope cage guide in an extra-deep shaft according to claim 8, wherein, the electrical control device comprises a battery (62), a controller (60), a voltage converter module (61) and an intrinsically safe wireless communication module (59), wherein, the battery (62) is connected to the voltage converter module (61), the voltage converter module (61) is connected to the controller (60), the intrinsically sate wireless communication module (59), the brushless DC motor (20), the motor driver (21) and the mini-type DC speed-reducing motor (53) respectively, and the controller (60) is connected to the motor driver (21), the brushless DC motor (20), the mini-type DC speed-reducing motor (53), the intrinsically safe wireless communication module (59) and the intrinsically safe camera (52) respectively.

10. The vertical rope climbing inspection robot for a steel-rope cage guide in an extra-deep shaft according to claim 1, wherein, the inspection robot further comprises a lead-in device, the lead-in device comprises a driving mechanism lead-in device (4), an electrical control device lead-in device (7) and a carrying mechanism lead-in device (10), wherein, the driving mechanism lead-in device (4) is arranged on the driver housing (9), the electrical control device lead-in device (7) is arranged on the electrical control device housing (8), and the carrying mechanism lead-in device (10) is arranged on the carrying mechanism housing (11).
